(19) United States
(12) Patent Application Publication
(10) Pub. No.: US 2025/0087428 A1
(43) Pub. Date: Mar. 13, 2025

(54) CAPACITOR ASSEMBLY PACKAGE STRUCTURE, CAPACITOR STRUCTURE AND METHOD OF MANUFACTURING THE SAME, AND ELECTRONIC DEVICE

(71) Applicant: APAQ TECHNOLOGY CO., LTD., Miaoli County (TW)

(72) Inventors: CHIEH LIN, HSINCHU COUNTY (TW); YI-YING WANG, Hsinchu City (TW)

(21) Appl. No.: 18/624,283

(22) Filed: Apr. 2, 2024

(30) Foreign Application Priority Data
Sep. 12, 2023 (TW) 112134575

(51) Int. Cl. H01G 9/26; H01G 9/00; H01G 9/008; H01G 9/042; H01G 9/052

(52) U.S. Cl. CPC H01G 9/26; H01G 9/0029; H01G 9/008; H01G 9/042; H01G 9/052

(57) ABSTRACT

A capacitor assembly package structure, capacitor structure and method of manufacturing the same, and electronic device. The capacitor assembly package structure includes a capacitor assembly, an insulating package body and an electrode assembly. The capacitor assembly includes a plurality of capacitor structures that are stacked in sequence and electrically connected to each other. The insulating package body is configured to encapsulate a plurality of the capacitor structures. The electrode assembly includes a first electrode structure and a second electrode structure. Each of the capacitor structures includes a sintered silver layer, and the sintered silver layer includes more than 95% pure silver material. The average thickness of the sintered silver layer can be less than or equal to 1 μm, and the resistivity of the sintered silver layer can be less than the resistivity of a silver glue material formed by mixing epoxy resin and silver powder.

### CROSS-REFERENCE TO RELATED PATENT APPLICATION

This application claims the benefit of priority to Taiwan Patent Application No. 112134575, filed on Sep. 12, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor, and more particularly to a capacitor assembly package structure, a capacitor structure, a method of manufacturing the capacitor structure, and an electronic device using the capacitor assembly package structure.

### BACKGROUND OF THE DISCLOSURE

In general, a plurality of capacitor elements is stacked together to form a stacked solid electrolytic capacitor with a high electrical capacity. In addition, the stacked solid electrolytic capacitor of the related art includes a plurality of capacitor elements and a lead frame. Each capacitor element includes an anode part, a cathode part and an insulating part. The insulating part is insulated from the anode part and the cathode part. More specifically, the cathode parts of the capacitor elements are stacked on top of one another. However, there is still room for improvement in the related art of the wound capacitor.

### SUMMARY OF THE DISCLOSURE

In response to the above-referenced technical inadequacy, the present disclosure provides a capacitor assembly package structure, a capacitor structure, a method of manufacturing the capacitor structure and an electronic device, which can be used to reduce or maintain the equivalent series resistance (ESR) of the capacitor assembly package structure.

In order to solve the above-mentioned problems, one of the technical aspects adopted by the present disclosure is to provide a capacitor assembly package structure, which includes a capacitor assembly, an insulating package body and an electrode assembly. The capacitor assembly includes a plurality of capacitor structures that are stacked in sequence and electrically connected to each other, and each of the capacitor structures has a positive electrode portion and a negative electrode portion. The insulating package body is configured to encapsulate a plurality of the capacitor structures. The electrode assembly includes a first electrode structure and a second electrode structure. The first electrode structure and the insulating package body cooperate with each other and are electrically connected to the positive electrode portion of the capacitor structure, and the second electrode structure and the insulating package body cooperate with each other and are electrically connected to the negative electrode portion of the capacitor structure. Each of the capacitor structures includes a sintered silver layer, and the sintered silver layer includes more than 95% pure silver material.

In order to solve the above-mentioned problems, another one of the technical aspects adopted by the present disclosure is to provide a capacitor structure configured to be applied to a capacitor assembly package structure, and the capacitor structure comprises a sintered silver layer, and the sintered silver layer includes more than 95% pure silver material.

In order to solve the above-mentioned problems, another one of the technical aspects adopted by the present disclosure is to provide an electronic device configured to use a capacitor assembly package structure, characterized in that the capacitor assembly package structure includes a capacitor assembly, an insulating package body and an electrode assembly. The capacitor assembly includes a plurality of capacitor structures that are stacked in sequence and electrically connected to each other, and each of the capacitor structures has a positive electrode portion and a negative electrode portion. The insulating package body is configured to encapsulate a plurality of the capacitor structures. The electrode assembly includes a first electrode structure and a second electrode structure. The first electrode structure and the insulating package body cooperate with each other and are electrically connected to the positive electrode portion of the capacitor structure, and the second electrode structure and the insulating package body cooperate with each other and are electrically connected to the negative electrode portion of the capacitor structure. Each of the capacitor structures includes a sintered silver layer, and the sintered silver layer includes more than 95% pure silver material.

Therefore, in the capacitor assembly package structure provided by the present disclosure, by virtue of “the capacitor assembly including a plurality of capacitor structures that are stacked in sequence and electrically connected to each other,” “the insulating package body being configured to encapsulate a plurality of the capacitor structures,” “each of the capacitor structures including a sintered silver layer” and “the sintered silver layer including more than 95% pure silver material,” an average thickness of the sintered silver layer can be less than or equal to 1 μm, and a resistivity of the sintered silver layer can be less than a resistivity of a silver glue material formed by mixing epoxy resin and silver powder, so as to reduce or maintain the equivalent series resistance of the capacitor assembly package structure.

More particularly, in the capacitor structure provided by the present disclosure, by virtue of “the capacitor structure including a sintered silver layer” and “the sintered silver layer including more than 95% pure silver material,” an average thickness of the sintered silver layer can be less than or equal to 1 μm, and a resistivity of the sintered silver layer can be less than a resistivity of a silver glue material formed by mixing epoxy resin and silver powder, so as to reduce or maintain the equivalent series resistance of the capacitor assembly package structure configured to use the capacitor structure.

More particularly, in the method for manufacturing the capacitor structure provided by the present disclosure, by virtue of “forming an insulating surrounding layer to be disposed around a first portion of the metal foil” “forming a conductive polymer layer to cover the first portion of the metal foil and contact the insulating surrounding layer” “forming a carbon glue layer to cover the conductive polymer layer and contact the insulating surrounding layer” “forming a silver material layer to cover the carbon glue layer and contact the insulating surrounding layer” and “sintering the silver material layer to form the sintered silver layer for covering the carbon glue layer and contacting the insulating surrounding layer,” an average thickness of the sintered silver layer can be less than or equal to 1 μm, and a resistivity of the sintered silver layer can be less than a resistivity of a silver glue material formed by mixing epoxy resin and silver powder, so as to reduce or maintain the equivalent series resistance of the capacitor assembly package structure configured to use the capacitor structure.

More particularly, in the method for manufacturing the capacitor structure provided by the present disclosure, by virtue of “forming an insulating surrounding layer to be disposed around a first portion of the metal foil” “forming a conductive polymer layer to cover the first portion of the metal foil and contact the insulating surrounding layer” “forming a silver material layer to cover the conductive polymer layer and contact the insulating surrounding layer” and “sintering the silver material layer to form the sintered silver layer for covering the conductive polymer layer and contacting the insulating surrounding layer,” an average thickness of the sintered silver layer can be less than or equal to 1 μm, and a resistivity of the sintered silver layer can be less than a resistivity of a silver glue material formed by mixing epoxy resin and silver powder, so as to reduce or maintain the equivalent series resistance of the capacitor assembly package structure configured to use the capacitor structure.

More particularly, in the electronic device provided by the present disclosure, by virtue of “the capacitor assembly including a plurality of capacitor structures that are stacked in sequence and electrically connected to each other,” “the insulating package body being configured to encapsulate a plurality of the capacitor structures,” “each of the capacitor structures including a sintered silver layer” and “the sintered silver layer including more than 95% pure silver material,” an average thickness of the sintered silver layer can be less than or equal to 1 μm, and a resistivity of the sintered silver layer can be less than a resistivity of a silver glue material formed by mixing epoxy resin and silver powder, so as to reduce or maintain the equivalent series resistance of the capacitor assembly package structure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method of manufacturing a capacitor structure provided by the first and fifth embodiments of the present disclosure;

FIG. 2 is a schematic view of steps S100 to S106 of the method of manufacturing the capacitor structure provided by the first embodiment of the present disclosure;

FIG. 3 is a schematic enlarged view of part III of FIG. 2;

FIG. 4 is a schematic view of step S108 of the method of manufacturing the capacitor structure provided by the first embodiment of the present disclosure;

FIG. 5 is a schematic enlarged view of part V of FIG. 4;

FIG. 6 is a schematic cross-sectional view of a capacitor assembly package structure provided by the second embodiment of the present disclosure;

FIG. 7 is a schematic cross-sectional view of the capacitor assembly package structure provided by the third embodiment of the present disclosure;

FIG. 8 is a schematic cross-sectional view of the capacitor assembly package structure provided by the fourth embodiment of the present disclosure;

FIG. 9 is a schematic view of steps S200 to S208 of the method of manufacturing the capacitor structure provided by the fifth embodiment of the present disclosure;

FIG. 10 is a schematic view of step S210 of the method of manufacturing the capacitor structure provided by the fifth embodiment of the present disclosure; and

FIG. 11 is a functional block diagram of an electronic device according to the sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

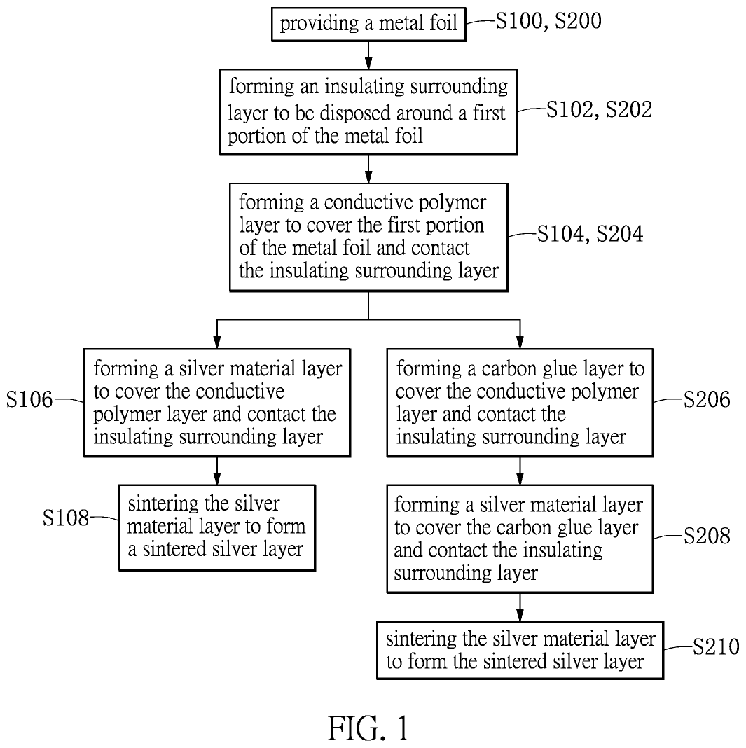

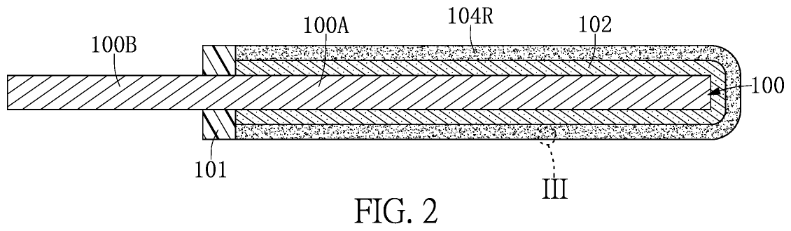

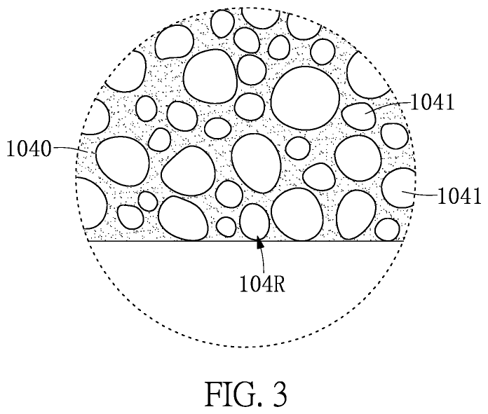

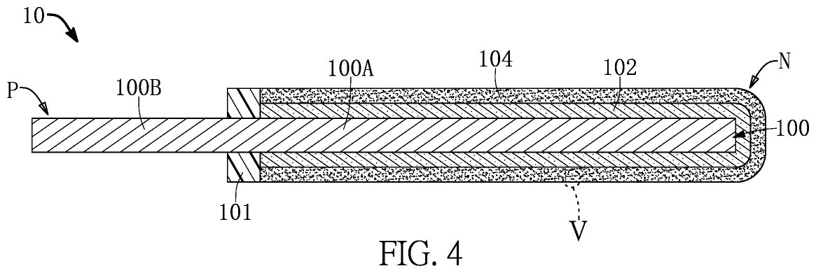

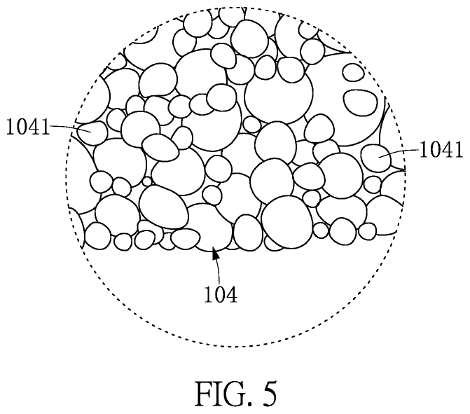

Referring to FIG. 1 to FIG. 5, a first embodiment of the present disclosure provides a method for manufacturing a capacitor structure 10, which includes: firstly, referring to FIG. 1 and FIG. 2, providing a metal foil 100 (step S100); next, referring to FIG. 1 and FIG. 2, forming an insulating surrounding layer 101 (or an insulating position-limiting layer) to be disposed around a first portion 100A of the metal foil 100 (step S102); then, referring to FIG. 1 and FIG. 2, forming a conductive polymer layer 102 to cover the first portion 100A of the metal foil 100 and contact the insulating surrounding layer 101 (step S104); afterward, referring to FIG. 1, FIG. 2 and FIG. 3, forming a silver material layer 104R (such as a nano silver material layer) to cover the conductive polymer layer 102 and contact the insulating surrounding layer 101 (step S106); and then referring to FIG. 1, FIG. 2, FIG. 4 and FIG. 5, sintering the silver material layer 104R as shown in FIG. 2 to form a sintered silver layer 104 (step S108) for covering the conductive polymer layer 102 and contacting the insulating surrounding layer 101. For example, the metal foil 100 may be aluminum foil, copper foil or any kind of conductive foil, and the surface of the metal foil 100 has a corrosion layer and an oxide layer formed on the corrosion layer. Moreover, the insulating surrounding layer 101 may be silicone, epoxy or any kind of insulating material. In addition, the conductive polymer layer 102 may be polyacetylene (PA), polypyrrole (PPy), polythiophene (PT), polyaniline (PANI), poly (p-phenylene) (PPP), poly (phenylene vinylene) (PPV), or the conductive polymer layer 102 may be polyphenylene sulfide, polypyrrole, polythiophene, polyphenylene, polythiazole, etc. However, the aforementioned details are disclosed for exemplary purposes only, and are not meant to limit the scope of the present disclosure.

It should be noted that, for example, as shown in FIG. 3, the silver material layer 104R includes a surfactant 1040, and the pure silver material 1041 (such as multiple pure silver nanoparticles) and the surfactant 1040 are mixed with each other to form a nano silver glue. Moreover, in the step S106 of sintering the silver material layer 104R to form the sintered silver layer 104, the surfactant 1040 of the silver material layer 104R would be completely removed but only the pure silver material 1041 (such as multiple pure silver nanoparticles) would be left, or most of the surfactant 1040 of the silver material layer 104R would be removed but more than 95% of the pure silver material 1041 (such as multiple pure silver nanoparticles) would be left (that is to say, the weight percentage or volume percentage of the pure silver material 1041 in the sintered silver layer 104 can exceed 95%, and the remaining ingredients may contain a small amount of surfactants or residues such as C, H, O, etc.). In addition, the surfactant 1040 can be an ionic surfactant or a non-ionic surfactant. However, the aforementioned details are disclosed for exemplary purposes only, and are not meant to limit the scope of the present disclosure.

Therefore, referring to FIG. 4 and FIG. 5, the capacitor structure 10 (also called a capacitor element) produced by the above-mentioned method for manufacturing the capacitor structure provided by the first embodiment of the present disclosure includes a metal foil 100, an insulating surrounding layer 101, a conductive polymer layer 102 and a sintered silver layer 104. More particularly, the capacitor structure 10 has a positive electrode portion P and a negative electrode portion N. The insulating surrounding layer 101 can be configured to be disposed on and around a first portion 100A of the metal foil 100. The conductive polymer layer 102 can be configured for covering the first portion 100A of the metal foil 100 and contacting the insulating surrounding layer 101, but the conductive polymer layer 102 does not contact the second portion 100B of the metal foil 100 through the barrier of the insulating surrounding layer 101. The sintered silver layer 104 can be configured for covering the conductive polymer layer 102 and contacting the insulating surrounding layer 101, but the sintered silver layer 104 does not contact the second portion 100B of the metal foil 100 through the barrier of the insulating surrounding layer 101. It should be noted that the sintered silver layer 104 includes more than 95% pure silver material (such as a nano silver material or a pure silver material 1041), so that the sintered silver layer 104 can also be called a sintered nano-silver layer or sintered nano-silver thin film. In addition, an average thickness of the sintered silver layer 104 can be less than or equal to 1 μm (or any positive integer less than or equal to 1 μm, so that the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder. For example, the average thickness of the sintered silver layer 104 can be between 100 nm and 1000 nm (or any positive integer between 100 nm and 1000 nm), and the resistivity of the sintered silver layer 104 can be between 1×10⁻⁵ Ω·cm and 1×10⁻⁶ Ω·cm (or between R×10⁻⁵ Ω·cm and R×10⁻⁶ Ω·cm, in which R can be any number), so that the present disclosure can effectively reduce the equivalent series resistance of the capacitor assembly package structure S through the sintered silver layer 104, or maintain the equivalent series resistance of the capacitor assembly package structure S through the sintered silver layer 104. Therefore, even if the average thickness of the sintered silver layer 104 can be reduced, and the equivalent series resistance of the capacitor assembly package structure S would not be increased (that is to say, even if the average thickness of the sintered silver layer 104 is reduced, the equivalent series resistance of the capacitor assembly package structure S using the sintered silver layer 104 can be maintained to be the same as the equivalent series resistance of a capacitor assembly package structure using silver glue formed by mixing epoxy resin and silver powder).

### Second Embodiment

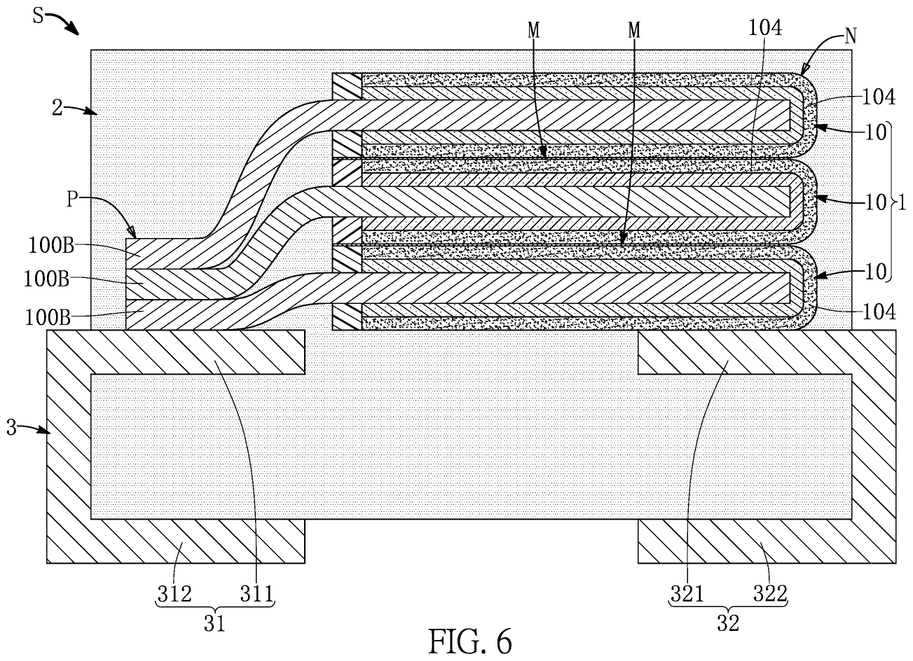

Referring to FIG. 6, a second embodiment of the present disclosure provides a capacitor assembly package structure S, which includes a capacitor assembly 1, an insulating package body 2 and an electrode assembly 3. That is to say, the plurality of capacitor structures 10 manufactured by the method provided by the first embodiment of the present disclosure can be applied to the capacitor assembly package structure S.

Firstly, referring to FIG. 4 and FIG. 6, the capacitor assembly 1 includes a plurality of capacitor structures 10 that are stacked in sequence and electrically connected to each other, each of the capacitor structures 10 has a positive electrode portion P and a negative electrode portion N, and each of the capacitor structures 10 includes a metal foil 100, an insulating surrounding layer 101, a conductive polymer layer 102 and a sintered silver layer 104. More particularly, as shown in FIG. 4, the insulating surrounding layer 101 can be configured to be disposed on and around a first portion 100A of the metal foil 100, the conductive polymer layer 102 can be configured for covering the first portion 100A of the metal foil 100 and contacting the insulating surrounding layer 101, and the sintered silver layer 104 can be configured for covering the conductive polymer layer 102 and contacting the insulating surrounding layer 101. Moreover, the sintered silver layer 104 can be an outermost layer of the capacitor structure 10, and the two sintered silver layers 104 of two adjacent capacitor structures 10 can be electrically connected to each other through a conductive material M (or without any conductive material). In addition, a second portion 100B of the metal foil 100 of the capacitor structure 10 is not covered (or enclosed) by the insulating surrounding layer 101, and the second portions 100B of the metal foils 100 of the capacitor structures 10 can be stacked in sequence. However, the aforementioned details are disclosed for exemplary purposes only, and are not meant to limit the scope of the present disclosure.

Moreover, as shown in FIG. 6, the insulating package body 2 can be configured to encapsulate (or cover, or enclose) a plurality of the capacitor structures 10. For example, the insulating package body 2 may be silicone, epoxy or any kind of insulating material. However, the aforementioned details are disclosed for exemplary purposes only, and are not meant to limit the scope of the present disclosure.

Furthermore, as shown in FIG. 6, the electrode assembly 3 includes a first electrode structure 31 and a second electrode structure 32. The first electrode structure 31 and the insulating package body 2 cooperate with each other and are electrically connected to the positive electrode portion P of the capacitor structure 10, the second electrode structure 32 and the insulating package body 2 cooperate with each other and are electrically connected to the negative electrode portion N of the capacitor structure 10, and the electrode assembly 3 can be a conductive pin assembly (such as a lead frame assembly). More particularly, when the electrode assembly 3 is the conductive pin assembly, the first electrode structure 31 of the electrode assembly 3 includes a first embedded portion 311 covered (or enclosed) by the insulating package body 2 and a first exposed portion 312 connected to the first embedded portion 311 and exposed from the insulating package body 2, the first embedded portion 311 of the first electrode structure 31 can be electrically connected to the positive electrode portion P of the capacitor structure 10 through a conductive material, and the first exposed portion 312 of the first electrode structure 31 can extend along an outer surface of the insulating package body 2. In addition, when the electrode assembly 3 is the conductive pin assembly, the second electrode structure 32 of the electrode assembly 3 includes a second embedded portion 321 covered (or enclosed) by the insulating package body 2 and a second exposed portion 322 connected to the second embedded portion 321 and exposed from the insulating package body 2, the second embedded portion 321 of the second electrode structure 32 can be electrically connected to the negative electrode portion N of the capacitor structure 10 through another conductive material, and the second exposed portion 322 of the second electrode structure 32 can extend along the outer surface of the insulating package body 2.

### Third Embodiment

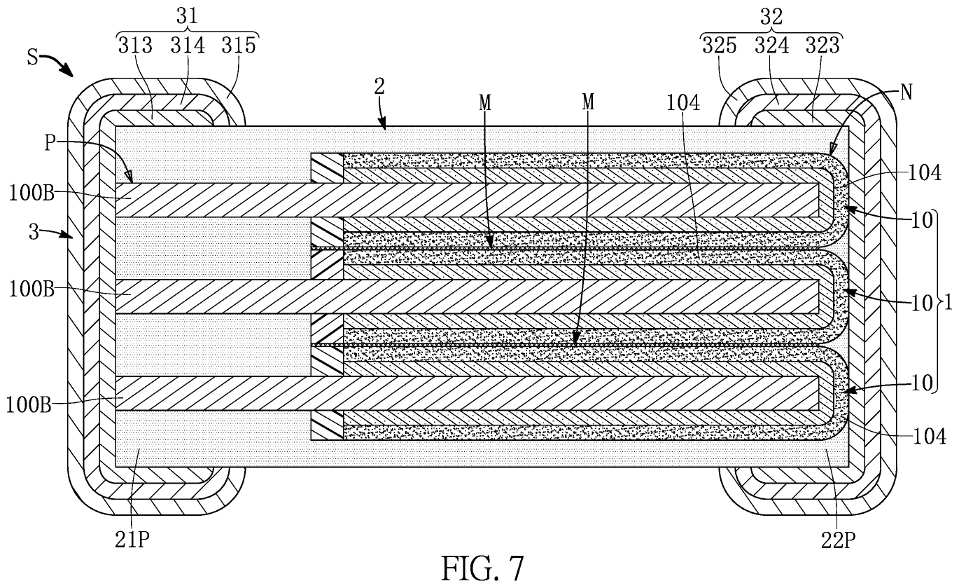

Referring to FIG. 7, a third embodiment of the present disclosure provides a capacitor assembly package structure S, which includes a capacitor assembly 1, an insulating package body 2 and an electrode assembly 3. Comparing FIG. 7 with FIG. 6, the main difference between the third embodiment and the second embodiment is as follows: in the third embodiment, the electrode assembly 3 can be a terminal electrode assembly (such as a lateral terminal assembly), and the second portions 100B of the metal foils 100 of the capacitor structures 10 can be separated from each other. More particularly, when the electrode assembly 3 is the terminal electrode assembly, the first electrode structure 31 of the electrode assembly 3 includes a first inner conductive layer 313 configured to cover (or enclose) a first side portion 21P of the insulating package body 2 and electrically contact (or connect with) the positive electrode portion P of the capacitor structure 10, a first intermediate conductive layer 314 configured to cover (or enclose) the first inner conductive layer 313, and a first outer conductive layer 315 configured to cover (or enclose) the first intermediate conductive layer 314. In addition, when the electrode assembly 3 is the terminal electrode assembly, the second electrode structure 32 of the electrode assembly 3 includes a second inner conductive layer 323 configured to cover (or enclose) a second side portion 22P of the insulating package body 2 and electrically contact (or connect with) the negative electrode portion N of the capacitor structure 10, a second intermediate conductive layer 324 configured to cover (or enclose) the second inner conductive layer 323, and a second outer conductive layer 325 configured to cover (or enclose) the second intermediate conductive layer 324. For example, the first inner conductive layer 313 can be one of a silver-containing material layer (such as an Ag layer) and a copper-containing material layer (such as a Cu layer), the first intermediate conductive layer 314 can be a nickel-containing material layer (such as a Ni layer), and the first outer conductive layer 315 can be a tin-containing material layer (such as a Sn layer). The second inner conductive layer 323 can be one of a silver-containing material layer (such as an Ag layer) and a copper-containing material layer (such as a Cu layer), the second intermediate conductive layer 324 can be a nickel-containing material layer (such as a Ni layer), and the second outer conductive layer 325 can be a tin-containing material layer (such as a Sn layer). However, the aforementioned details are disclosed for exemplary purposes only, and are not meant to limit the scope of the present disclosure.

### Fourth Embodiment

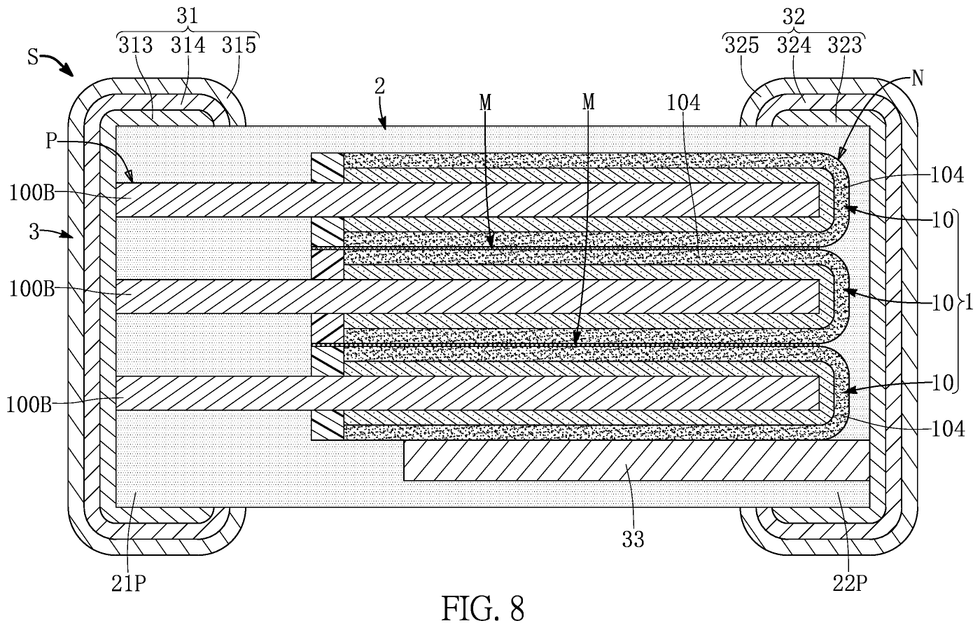

Referring to FIG. 8, a fourth embodiment of the present disclosure provides a capacitor assembly package structure S, which includes a capacitor assembly 1, an insulating package body 2 and an electrode assembly 3. Comparing FIG. 8 with FIG. 7, the main difference between the fourth embodiment and the third embodiment is as follows: in the fourth embodiment, when the electrode assembly 3 is the terminal electrode assembly, the capacitor structures 10 can be carried by a conductive carrier substrate 33, and the negative electrode portion N of the capacitor structure 10 can be electrically connected to the second electrode structure 32 of the electrode assembly 3 through the conductive carrier substrate 33.

### Fifth Embodiment

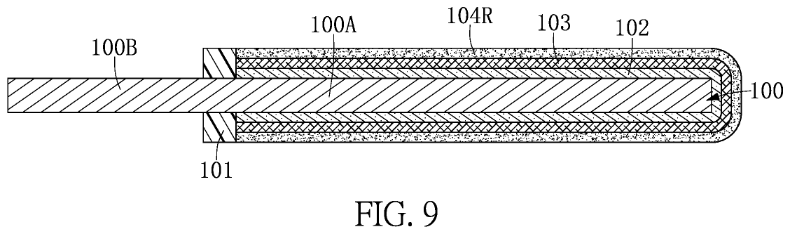

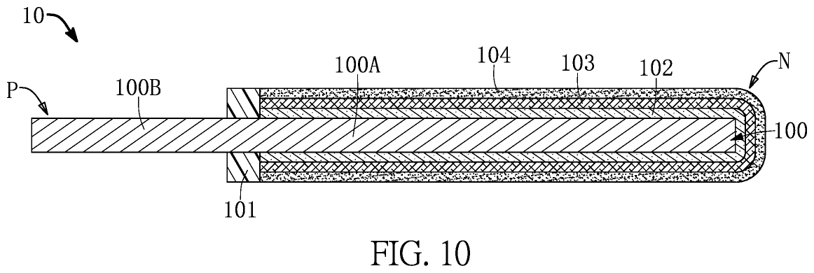

Referring to FIG. 1, FIG. 9 and FIG. 10, a fifth embodiment of the present disclosure provides a method for manufacturing a capacitor structure 10, which includes: firstly, referring to FIG. 1 and FIG. 9, providing a metal foil 100 (step S200); next, referring to FIG. 1 and FIG. 9, forming an insulating surrounding layer 101 (or an insulating position-limiting layer) to be disposed around a first portion 100A of the metal foil 100 (step S202); then, referring to FIG. 1 and FIG. 9, forming a conductive polymer layer 102 to cover the first portion 100A of the metal foil 100 and contact the insulating surrounding layer 101 (step S204); afterward, referring to FIG. 1 and FIG. 9, forming a carbon glue layer 103 to cover the conductive polymer layer 102 and contact the insulating surrounding layer 101 (step S206); next, referring to FIG. 1 and FIG. 9, forming a silver material layer 104R (such as a nano silver material layer) to cover the carbon glue layer 103 and contact the insulating surrounding layer 101 (step S208); then, referring to FIG. 1, FIG. 9 and FIG. 10, sintering the silver material layer 104R to form the sintered silver layer 104 (step S210) for covering the carbon glue layer 103 and contacting the insulating surrounding layer 101. For example, the metal foil 100 may be aluminum foil, copper foil or any kind of conductive foil, and the surface of the metal foil 100 has a corrosion layer and an oxide layer formed on the corrosion layer. Moreover, the insulating surrounding layer 101 may be silicone, epoxy or any kind of insulating material. In addition, the conductive polymer layer 102 may be polyacetylene (PA), polypyrrole (PPy), polythiophene (PT), polyaniline (PANI), poly (p-phenylene) (PPP), poly (phenylene vinylene) (PPV), or the conductive polymer layer 102 may be polyphenylene sulfide, polypyrrole, polythiophene, polyphenylene, polythiazole, etc. However, the aforementioned details are disclosed for exemplary purposes only, and are not meant to limit the scope of the present disclosure.

It should be noted that, for example, as shown in FIG. 3, the same as the first embodiment, the silver material layer 104R includes a surfactant 1040, and the pure silver material 1041 (such as multiple pure silver nanoparticles) and the surfactant 1040 are mixed with each other to form a nano silver glue. Moreover, in the step S210 of sintering the silver material layer 104R to form the sintered silver layer 104, the surfactant 1040 of the silver material layer 104R would be completely removed but only the pure silver material 1041 (such as multiple pure silver nanoparticles) would be left, or most of the surfactant 1040 of the silver material layer 104R would be removed but more than 95% of the pure silver material 1041 (such as multiple pure silver nanoparticles) would be left (that is to say, the weight percentage or volume percentage of the pure silver material 1041 in the sintered silver layer 104 can exceed 95%, and the remaining ingredients may contain a small amount of surfactants or residues such as C, H, O, etc.). In addition, the surfactant 1040 can be an ionic surfactant or a non-ionic surfactant. However, the aforementioned details are disclosed for exemplary purposes only, and are not meant to limit the scope of the present disclosure.

Therefore, referring to FIG. 10, the capacitor structure 10 (also called a capacitor element) produced by the above-mentioned method for manufacturing the capacitor structure provided by the fifth embodiment of the present disclosure includes a metal foil 100, an insulating surrounding layer 101, a conductive polymer layer 102, a carbon glue layer 103 and a sintered silver layer 104. More particularly, the capacitor structure 10 has a positive electrode portion P and a negative electrode portion N. The insulating surrounding layer 101 can be configured to be disposed on and around a first portion 100A of the metal foil 100. The conductive polymer layer 102 can be configured for covering the first portion 100A of the metal foil 100 and contacting the insulating surrounding layer 101, but the conductive polymer layer 102 does not contact the second portion 100B of the metal foil 100 through the barrier of the insulating surrounding layer 101. The carbon glue layer 103 can be configured for covering the conductive polymer layer 102 and contacting the insulating surrounding layer 101, but the carbon glue layer 103 does not contact the second portion 100B of the metal foil 100 through the barrier of the insulating surrounding layer 101. The sintered silver layer 104 can be configured for covering the carbon glue layer 103 and contacting the insulating surrounding layer 101, but the sintered silver layer 104 does not contact the second portion 100B of the metal foil 100 through the barrier of the insulating surrounding layer 101. It should be noted that as shown in FIG. 3, the sintered silver layer 104 includes more than 95% pure silver material (such as a nano silver material or a pure silver material 1041), so that the sintered silver layer 104 can also be called a sintered nano-silver layer or sintered nano-silver thin film. In addition, an average thickness of the sintered silver layer 104 can be less than or equal to 1 μm (or any positive integer less than or equal to 1 μm, so that the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder. For example, the average thickness of the sintered silver layer 104 can be between 100 nm and 1000 nm (or any positive integer between 100 nm and 1000 nm), and the resistivity of the sintered silver layer 104 can be between 1×10⁻⁵ Ω·cm and 1×10⁻⁶ Ω·cm (or between R×10⁻⁵ Ω·cm and R×10⁻⁶ Ω·cm, in which R can be any number), so that the present disclosure can effectively reduce the equivalent series resistance of the capacitor assembly package structure S through the sintered silver layer 104, or maintain the equivalent series resistance of the capacitor assembly package structure S through the sintered silver layer 104. Therefore, even if the average thickness of the sintered silver layer 104 can be reduced, and the equivalent series resistance of the capacitor assembly package structure S would not be increased (that is to say, even if the average thickness of the sintered silver layer 104 is reduced, the equivalent series resistance of the capacitor assembly package structure S using the sintered silver layer 104 can be maintained to be the same as the equivalent series resistance of a capacitor assembly package structure using silver glue formed by mixing epoxy resin and silver powder).

### Sixth Embodiment

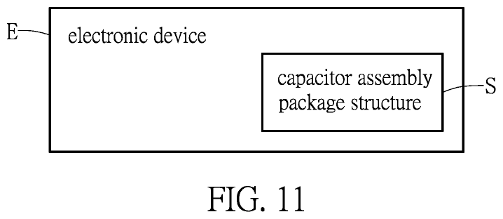

Referring to FIG. 11, a sixth embodiment of the present disclosure provides an electronic device E configured to use a capacitor assembly package structure S as provided in one of the second to fourth embodiments. For example, the electronic device E may be a portable electronic device (such as a desktop computer, a notebook computer, or a tablet computer) or a mobile device (such as a car, a boat, an airplane, or any other means of transportation). However, the aforementioned details are disclosed for exemplary purposes only, and are not meant to limit the scope of the present disclosure.

### Beneficial Effects of the Embodiments

In conclusion, in the capacitor assembly package structure S provided by the present disclosure, by virtue of “the capacitor assembly 1 including a plurality of capacitor structures 10 that are stacked in sequence and electrically connected to each other,” “the insulating package body 2 being configured to encapsulate a plurality of the capacitor structures 10,” “each of the capacitor structures 10 including a sintered silver layer 104” and “the sintered silver layer 104 including more than 95% pure silver material 1041,” an average thickness of the sintered silver layer 104 can be less than or equal to 1 μm (that is to say, the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder, so as to reduce or maintain the equivalent series resistance of the capacitor assembly package structure S.

More particularly, in the capacitor structure 10 provided by the present disclosure, by virtue of “the capacitor structure 10 including a sintered silver layer 104” and “the sintered silver layer 104 including more than 95% pure silver material 1041,” an average thickness of the sintered silver layer 104 can be less than or equal to 1 μm (that is to say, the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder, so as to reduce or maintain the equivalent series resistance of the capacitor assembly package structure S configured to use the capacitor structure 10.

More particularly, in the method for manufacturing the capacitor structure 10 provided by the present disclosure, by virtue of “forming an insulating surrounding layer 101 to be disposed around a first portion 100A of the metal foil 100” “forming a conductive polymer layer 102 to cover the first portion 100A of the metal foil 100 and contact the insulating surrounding layer 101” “forming a carbon glue layer 103 to cover the conductive polymer layer 102 and contact the insulating surrounding layer 101” “forming a silver material layer 104R to cover the carbon glue layer 103 and contact the insulating surrounding layer 101” and “sintering the silver material layer 104R to form the sintered silver layer 104 for covering the carbon glue layer 103 and contacting the insulating surrounding layer 101,” an average thickness of the sintered silver layer 104 can be less than or equal to 1 μm (that is to say, the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder, so as to reduce or maintain the equivalent series resistance of the capacitor assembly package structure S configured to use the capacitor structure 10.

More particularly, in the method for manufacturing the capacitor structure 10 provided by the present disclosure, by virtue of “forming an insulating surrounding layer 101 to be disposed around a first portion 100A of the metal foil 100” “forming a conductive polymer layer 102 to cover the first portion 100A of the metal foil 100 and contact the insulating surrounding layer 101” “forming a silver material layer 104R to cover the conductive polymer layer 102 and contact the insulating surrounding layer 101” and “sintering the silver material layer 104R to form the sintered silver layer 104 for covering the conductive polymer layer 102 and contacting the insulating surrounding layer 101,” an average thickness of the sintered silver layer 104 can be less than or equal to 1 μm (that is to say, the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder, so as to reduce or maintain the equivalent series resistance of the capacitor assembly package structure S configured to use the capacitor structure 10.

More particularly, in the electronic device provided by the present disclosure, by virtue of “the capacitor assembly 1 including a plurality of capacitor structures 10 that are stacked in sequence and electrically connected to each other,” “the insulating package body 2 being configured to encapsulate a plurality of the capacitor structures 10,” “each of the capacitor structures 10 including a sintered silver layer 104” and “the sintered silver layer 104 including more than 95% pure silver material 1041,” an average thickness of the sintered silver layer 104 can be less than or equal to 1 μm (that is to say, the overall thickness of the capacitor assembly package structure S can be reduced, and the number of stacked layers of the multiple capacitor structures 10 can be increased), and a resistivity of the sintered silver layer 104 can be less than a resistivity of a silver glue material (i.e., silver glue that is not made by sintering) formed by mixing epoxy resin and silver powder, so as to reduce or maintain the equivalent series resistance of the capacitor assembly package structure S.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A capacitor assembly package structure, comprising:
a capacitor assembly including a plurality of capacitor structures that are stacked in sequence and electrically connected to each other, wherein each of the capacitor structures has a positive electrode portion and a negative electrode portion;
an insulating package body configured to encapsulate a plurality of the capacitor structures; and
an electrode assembly including a first electrode structure and a second electrode structure, wherein the first electrode structure and the insulating package body cooperate with each other and are electrically connected to the positive electrode portion of the capacitor structure, and the second electrode structure and the insulating package body cooperate with each other and are electrically connected to the negative electrode portion of the capacitor structure;
wherein each of the capacitor structures includes a sintered silver layer, and the sintered silver layer includes more than 95% pure silver material.

2. The capacitor assembly package structure according to claim 1,
wherein each of the capacitor structures includes a metal foil, an insulating surrounding layer disposed around a first portion of the metal foil, a conductive polymer layer for covering the first portion of the metal foil and contacting the insulating surrounding layer and a carbon glue layer for covering the conductive polymer layer and contacting the insulating surrounding layer, and the sintered silver layer is configured for covering the carbon glue layer and contacting the insulating surrounding layer;
wherein the sintered silver layer is an outermost layer of the capacitor structure, and the two sintered silver layers of two adjacent ones of the capacitor structures are electrically connected to each other through a conductive material;
wherein a second portion of the metal foil of each of the capacitor structures is not covered by the insulating surrounding layer, and the second portions of the metal foils of the capacitor structures are stacked in sequence or separate from each other;
wherein an average thickness of the sintered silver layer is less than or equal to 1 μm, and a resistivity of the sintered silver layer is less than a resistivity of a silver glue material formed by mixing epoxy resin and silver powder;
wherein the average thickness of the sintered silver layer is between 100 nm and 1000 nm, and the resistivity of the sintered silver layer is between 1×10⁻⁵ Ω·cm and 1×10⁻⁶ Ω·cm, to reduce or maintain an equivalent series resistance of the capacitor assembly package structure;
wherein the electrode assembly is a conductive pin assembly or a terminal electrode assembly;
wherein, when the electrode assembly is the conductive pin assembly, the first electrode structure of the electrode assembly includes a first embedded portion covered by the insulating package body and a first exposed portion connected to the first embedded portion and exposed from the insulating package body, the first embedded portion of the first electrode structure is electrically connected to the positive electrode portion of the capacitor structure, and the first exposed portion of the first electrode structure extends along an outer surface of the insulating package body;
wherein, when the electrode assembly is the conductive pin assembly, the second electrode structure of the electrode assembly includes a second embedded portion covered by the insulating package body and a second exposed portion connected to the second embedded portion and exposed from the insulating package body, the second embedded portion of the second electrode structure is electrically connected to the negative electrode portion of the capacitor structure, and the second exposed portion of the second electrode structure extends along the outer surface of the insulating package body;
wherein, when the electrode assembly is the terminal electrode assembly, the first electrode structure of the electrode assembly includes a first inner conductive layer configured to cover a first side portion of the insulating package body and electrically contact the positive electrode portion of the capacitor structure, a first intermediate conductive layer configured to cover the first inner conductive layer, and a first outer conductive layer configured to cover the first intermediate conductive layer, the first inner conductive layer is one of a silver-containing material layer and a copper-containing material layer, the first intermediate conductive layer is a nickel-containing material layer, and the first outer conductive layer is a tin-containing material layer;
wherein, when the electrode assembly is the terminal electrode assembly, the second electrode structure of the electrode assembly includes a second inner conductive layer configured to cover a second side portion of the insulating package body and electrically contact the negative electrode portion of the capacitor structure, a second intermediate conductive layer configured to cover the second inner conductive layer, and a second outer conductive layer configured to cover the second intermediate conductive layer, the second inner conductive layer is one of a silver-containing material layer and a copper-containing material layer, the second intermediate conductive layer is a nickel-containing material layer, and the second outer conductive layer is a tin-containing material layer;
wherein, when the electrode assembly is the terminal electrode assembly, the capacitor structures are carried by a conductive carrier substrate, and the negative electrode portion of the capacitor structure is electrically connected to the second electrode structure of the electrode assembly through the conductive carrier substrate.

3. The capacitor assembly package structure according to claim 1,
wherein each of the capacitor structures includes a metal foil, an insulating surrounding layer disposed around a first portion of the metal foil and a conductive polymer layer for covering the first portion of the metal foil and contacting the insulating surrounding layer, and the sintered silver layer is configured for covering the conductive polymer layer and contacting the insulating surrounding layer;
wherein the sintered silver layer is an outermost layer of the capacitor structure, and the two sintered silver layers of two adjacent ones of the capacitor structures are electrically connected to each other through a conductive material;
wherein a second portion of the metal foil of each of the capacitor structures is not covered by the insulating surrounding layer, and the second portions of the metal foils of the capacitor structures are stacked in sequence or separate from each other;
wherein an average thickness of the sintered silver layer is less than or equal to 1 μm, and a resistivity of the sintered silver layer is less than a resistivity of a silver glue material formed by mixing epoxy resin and silver powder;
wherein the average thickness of the sintered silver layer is between 100 nm and 1000 nm, and the resistivity of the sintered silver layer is between 1×10⁻⁵ Ω·cm and 1×10⁻⁶ Ω·cm, to reduce or maintain an equivalent series resistance of the capacitor assembly package structure;
wherein the electrode assembly is a conductive pin assembly or a terminal electrode assembly;
wherein, when the electrode assembly is the conductive pin assembly, the first electrode structure of the electrode assembly includes a first embedded portion covered by the insulating package body and a first exposed portion connected to the first embedded portion and exposed from the insulating package body, the first embedded portion of the first electrode structure is electrically connected to the positive electrode portion of the capacitor structure, and the first exposed portion of the first electrode structure extends along an outer surface of the insulating package body;
wherein, when the electrode assembly is the conductive pin assembly, the second electrode structure of the electrode assembly includes a second embedded portion covered by the insulating package body and a second exposed portion connected to the second embedded portion and exposed from the insulating package body, the second embedded portion of the second electrode structure is electrically connected to the negative electrode portion of the capacitor structure, and the second exposed portion of the second electrode structure extends along the outer surface of the insulating package body;
wherein, when the electrode assembly is the terminal electrode assembly, the first electrode structure of the electrode assembly includes a first inner conductive layer configured to cover a first side portion of the insulating package body and electrically contact the positive electrode portion of the capacitor structure, a first intermediate conductive layer configured to cover the first inner conductive layer, and a first outer conductive layer configured to cover the first intermediate conductive layer, the first inner conductive layer is one of a silver-containing material layer and a copper-containing material layer, the first intermediate conductive layer is a nickel-containing material layer, and the first outer conductive layer is a tin-containing material layer;
wherein, when the electrode assembly is the terminal electrode assembly, the second electrode structure of the electrode assembly includes a second inner conductive layer configured to cover a second side portion of the insulating package body and electrically contact the negative electrode portion of the capacitor structure, a second intermediate conductive layer configured to cover the second inner conductive layer, and a second outer conductive layer configured to cover the second intermediate conductive layer, the second inner conductive layer is one of a silver-containing material layer and a copper-containing material layer, the second intermediate conductive layer is a nickel-containing material layer, and the second outer conductive layer is a tin-containing material layer;
wherein, when the electrode assembly is the terminal electrode assembly, the capacitor structures are carried by a conductive carrier substrate, and the negative electrode portion of the capacitor structure is electrically connected to the second electrode structure of the electrode assembly through the conductive carrier substrate.

4. A capacitor structure configured to be applied to a capacitor assembly package structure, wherein the capacitor structure comprises a sintered silver layer, and the sintered silver layer includes more than 95% pure silver material.

5. The capacitor structure according to claim 4,
wherein the capacitor structure includes a metal foil, an insulating surrounding layer disposed around a first portion of the metal foil, a conductive polymer layer for covering the first portion of the metal foil and contacting the insulating surrounding layer and a carbon glue layer for covering the conductive polymer layer and contacting the insulating surrounding layer, and the sintered silver layer is configured for covering the carbon glue layer and contacting the insulating surrounding layer;
wherein the sintered silver layer is an outermost layer of the capacitor structure;
wherein a second portion of the metal foil of the capacitor structure is not covered by the insulating surrounding layer.

6. The capacitor structure according to claim 4,
wherein the capacitor structure includes a metal foil, an insulating surrounding layer disposed around a first portion of the metal foil and a conductive polymer layer for covering the first portion of the metal foil and contacting the insulating surrounding layer, and the sintered silver layer is configured for covering the conductive polymer layer and contacting the insulating surrounding layer;
wherein the sintered silver layer is an outermost layer of the capacitor structure;
wherein a second portion of the metal foil of the capacitor structure is not covered by the insulating surrounding layer.

7. A method for manufacturing the capacitor structure as claimed in claim 4, wherein the method for manufacturing the capacitor structure comprises:
providing a metal foil;
forming an insulating surrounding layer to be disposed around a first portion of the metal foil;
forming a conductive polymer layer to cover the first portion of the metal foil and contact the insulating surrounding layer;
forming a carbon glue layer to cover the conductive polymer layer and contact the insulating surrounding layer;
forming a silver material layer to cover the carbon glue layer and contact the insulating surrounding layer; and
sintering the silver material layer to form the sintered silver layer for covering the carbon glue layer and contacting the insulating surrounding layer;
wherein the silver material layer includes a surfactant, and the pure silver material and the surfactant are mixed with each other;
wherein the surfactant is an ionic surfactant or a non-ionic surfactant;
wherein an average thickness of the sintered silver layer is less than or equal to 1 μm, and a resistivity of the sintered silver layer is less than a resistivity of a silver glue material formed by mixing epoxy resin and silver powder;
wherein the average thickness of the sintered silver layer is between 100 nm and 1000 nm, and the resistivity of the sintered silver layer is between 1×10⁻⁵ Ω·cm and 1×10⁻⁶ Ω·cm, to reduce or maintain an equivalent series resistance of a capacitor assembly package structure configured to use the capacitor structure.

8. A method for manufacturing the capacitor structure as claimed in claim 4, wherein the method for manufacturing the capacitor structure comprises:
providing a metal foil;
forming an insulating surrounding layer to be disposed around a first portion of the metal foil;
forming a conductive polymer layer to cover the first portion of the metal foil and contact the insulating surrounding layer;
forming a silver material layer to cover the conductive polymer layer and contact the insulating surrounding layer; and
sintering the silver material layer to form the sintered silver layer for covering the conductive polymer layer and contacting the insulating surrounding layer;
wherein the silver material layer includes a surfactant, and the pure silver material and the surfactant are mixed with each other;
wherein the surfactant is an ionic surfactant or a non-ionic surfactant;
wherein an average thickness of the sintered silver layer is less than or equal to 1 μm, and a resistivity of the sintered silver layer is less than a resistivity of a silver glue material formed by mixing epoxy resin and silver powder;
wherein the average thickness of the sintered silver layer is between 100 nm and 1000 nm, and the resistivity of the sintered silver layer is between 1×10⁻⁵ Ω·cm and 1×10⁻⁶ Ω·cm, to reduce or maintain an equivalent series resistance of a capacitor assembly package structure configured to use the capacitor structure.

9. An electronic device configured to use a capacitor assembly package structure, characterized in that the capacitor assembly package structure comprises:
a capacitor assembly including a plurality of capacitor structures that are stacked in sequence and electrically connected to each other, wherein each of the capacitor structures has a positive electrode portion and a negative electrode portion;
an insulating package body configured to encapsulate a plurality of the capacitor structures; and
an electrode assembly including a first electrode structure and a second electrode structure, wherein the first electrode structure and the insulating package body cooperate with each other and are electrically connected to the positive electrode portion of the capacitor structure, and the second electrode structure and the insulating package body cooperate with each other and are electrically connected to the negative electrode portion of the capacitor structure;
wherein each of the capacitor structures includes a sintered silver layer, and the sintered silver layer includes more than 95% pure silver material.

10. The electronic device according to claim 9,
wherein each of the capacitor structures includes a metal foil, an insulating surrounding layer disposed around a first portion of the metal foil and a conductive polymer layer for covering the first portion of the metal foil and contacting the insulating surrounding layer, and the sintered silver layer is configured for covering the conductive polymer layer and contacting the insulating surrounding layer;
wherein the sintered silver layer is an outermost layer of the capacitor structure, and the two sintered silver layers of two adjacent ones of the capacitor structures are electrically connected to each other through a conductive material;
wherein a second portion of the metal foil of each of the capacitor structures is not covered by the insulating surrounding layer, and the second portions of the metal foils of the capacitor structures are stacked in sequence or separate from each other;
wherein an average thickness of the sintered silver layer is less than or equal to 1 μm, and a resistivity of the sintered silver layer is less than a resistivity of a silver glue material formed by mixing epoxy resin and silver powder;
wherein the average thickness of the sintered silver layer is between 100 nm and 1000 nm, and the resistivity of the sintered silver layer is between 1×10⁻⁵ Ω·cm and 1×10⁻⁶ Ω·cm, to reduce or maintain an equivalent series resistance of the capacitor assembly package structure.
